(19) United States
(12) Patent Application Publication
(10) Pub. No.: US 2014/0101159 A1
(43) Pub. Date: Apr. 10, 2014

(54) Knowledgebase Query Analysis

(71) Applicant: IntelliResponse Systems Inc., Toronto (CA)

(72) Inventors: David T. Lloyd, Toronto (CA); Darren Redfern, Toronto (CA); Kristy Anstett Campbell, Toronto (CA); Rod Hardman, Toronto (CA)

(73) Assignee: IntelliResponse Systems Inc., Toronto (CA)

(21) Appl. No.: 14/046,415

(22) Filed: Oct. 4, 2013

Related U.S. Application Data
(60) Provisional application No. 61/709,746, filed on Oct. 4, 2012.

(51) Int. Cl. G06F 17/30

(52) U.S. Cl. CPC G06F 17/30976
USPC 707/737

(57) ABSTRACT

A computerized method of analyzing a knowledgebase comprising; assembling a collection of queries made by users to obtain information from the knowledgebase; identifying in each query, sets of collocated words in that query to form a list of collocated word sets in the collection; from the list, identifying and presenting frequently collocated word sets in the collection. Likewise, a histogram of scaled relative difference between the frequency of word sets at first and second time intervales may be presented.

### CROSS-REFERENCE TO RELATED APPLICATIONS

This application claims priority from U.S. Provisional Patent Application No. 61/709,746 filed Oct. 4, 2012, the contents of which are hereby incorporated herein by reference.

### FIELD OF THE INVENTION

The present invention relates generally to data analysis, and more particularly to software, devices and methods for analysing, and optionally improving, knowledge bases and the handling of queries to such knowledge bases.

### BACKGROUND OF THE INVENTION

In recent years, computerized searching of data has become prevalent. As the public Internet has grown, so has the need for indexing and organizing data.

One search technique that is particularly useful in searching contained amounts of information is disclosed in U.S. Pat. No. 7,171,409, the contents of which are hereby incorporated by reference. As disclosed therein, a knowledgebase may be searched by receiving a natural language query. Based on the query, the best one of many responses may be presented.

Using natural language queries to query a knowledgebase may be an effective way to extract information from the knowledge base. At the same time, the nature of a presented query may identify a deficiency or flaw in the content of the knowledgebase or in how it is being searched. Similarly, an analysis of many queries may provide insight into a perception or a behavior on the part of users making the queries.

Accordingly, there remains a need for effectively analyzing data derived from queries and using the analysis to extract further information, and possibly refine knowledge bases and search techniques.

### SUMMARY OF THE INVENTION

In accordance with an aspect of the present disclosure, there is provided a computerized method of analyzing a knowledgebase comprising: assembling a collection of queries made by users to obtain information from the knowledgebase; identifying in each query, sets of collocated words in that query to form a list of collocated word sets in the collection; from the list, identifying and presenting frequently collocated word sets in the collection.

In accordance with another aspect of the present disclosure there is provided a computerized method of analyzing a knowledgebase. The method comprises assembling a collection of queries made by users to obtain information from the knowledgebase; identifying in each query in the collection in a first and second time interval, word sets in that query and theft frequency to form a first and second list of frequently used word sets in the collection in the first time interval and second time intervals respectively. For each word set in the first list and the second list, a relative difference between theft respective frequencies in the first list and second list is calculated. Each relative difference is scaled by a scale factor proportional to the frequency for that word set in the first or second interval to form scaled relative differences. A histogram of the scaled relative differences may be generated and presented. The histogram may be presented as a tag cloud.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 illustrates a computer network and network interconnected computing device, operable to analyse query data and provide results, exemplary of an embodiment of the present invention;

FIG. 2 is a functional block diagram of software stored and executing at the device of FIG. 1;

FIG. 3 is a diagram illustrating a database schema for a database used by a device of FIG. 1;

FIG. 4 depicts a flow chart illustrating the execution of software at the device of FIG. 1, exemplary of an embodiment of the present invention;

FIG. 5 is a diagram illustrating a database schema for a database used by a device of FIG. 1;

FIG. 6 is a flow chart illustrating the execution of software at the device of FIG. 1, exemplary of an embodiment of the present invention;

FIG. 7 illustrates exemplary output provided by the device of FIG. 1;

FIG. 8 is a diagram illustrating a further database schema for a database used by a device of FIG. 1;

FIGS. 9-11 illustrate exemplary output provided by the device of FIG. 1

### DETAILED DESCRIPTION

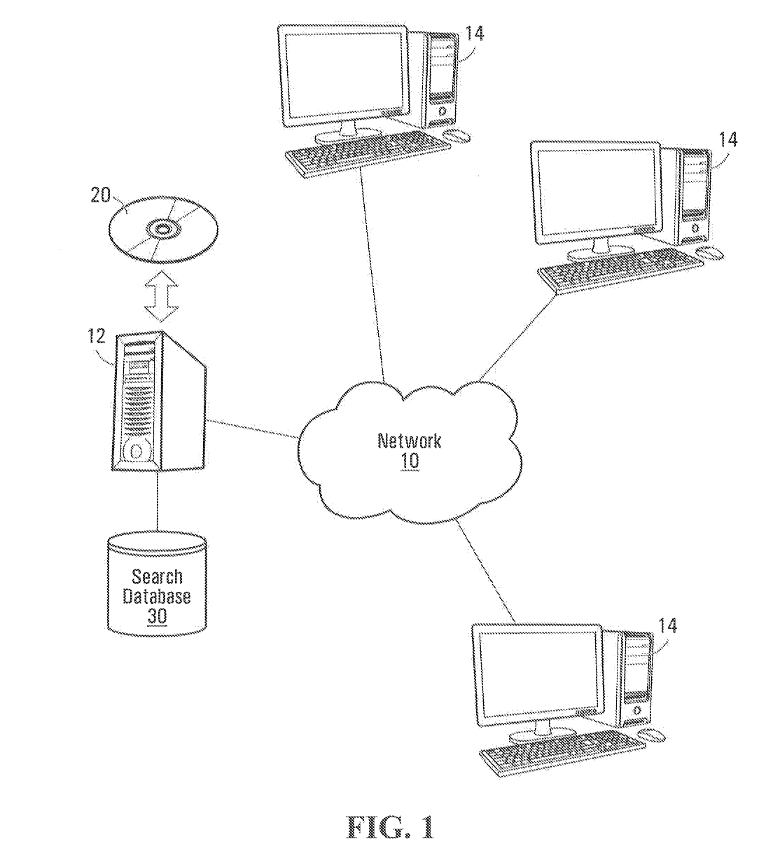

FIG. 1 illustrates a network interconnected computing device 12. Computing device 12 which may be a conventional network server is a device exemplary of the present invention including software adapting it to operate in manners exemplary of embodiments of the present invention.

As illustrated, computing device 12 is in communication with a computer network 10 in communication with other computing devices such as end-user computing devices 14 and other computer servers (not specifically illustrated). Network 10 is preferably the public Internet, but could similarly be a private local area packet switched data network coupled to computing device 12. So, network 10 could, for example, be an Internet protocol, X.25, IPX compliant or similar network.

Example end-user computing devices 14 are illustrated. End-user computing devices 14 are conventional network interconnected computers, used to access data from network interconnected servers, such as computing device 12. Device 12 may, for example, take the form of a person computer, laptop, tablet, mobile phone, or other programmable computing device.

Example computing device 12 preferably includes a network interface physically connecting computing device 12 to data network 10, and a processor coupled to conventional computer memory. Example computing device 12 may further include input and output peripherals such as a keyboard, display and mouse. As well, computing device 12 may include a peripheral usable to load software exemplary of the present invention into its memory for execution from a software readable medium, such as medium 20. As such, computing device 12 includes a conventional filesystem, preferably controlled and administered by the operating system governing overall operation of computing device 12. This filesystem preferably hosts search data in database 30, and analysis software 46 exemplary of an embodiment of the present invention, as detailed below. In the illustrated embodiment, computing device 12 also includes hypertext transfer protocol (“HTTP”) files used to provide an administrator or other user with an interface to access computing device 12.

As will become apparent, computing device 12 includes software 46 capable of analyzing search information, representative of natural language user queries to a knowledgebase. In particular, exemplary software 46 is capable of analyzing text queries to locate and analyze frequently used words, or sets of two or words (word clusters), and extract data therefrom that may be used to identify themes in queries presented by the user. In the depicted embodiment, the word clusters take the form of single words or collocated words in a query. In an embodiment, the word clusters are collocated word pairs occurring in the queries. In a further embodiment, the word clusters are adjacent words—and may be adjacent word pairs, or three, four or more adjacent words. Possibly, single words may also be considered and treated as word clusters.

In particular, computing device 12 maintains database 30 including a collection of user queries presented to search software used to query the content of a knowledgebase. In the depicted embodiment, computing device 12 may maintain a database of natural language queries presented to a natural language query interface. For example, computing device 12 may include a database that stores user queries presented to search software detailed in the '409 patent. In an alternate embodiment, database 30 may store an entire database containing a knowledgebase and queries made to that knowledgebase.

As disclosed in the '409 patent, natural language user queries may be received at a computing device and parsed. Stored Boolean expressions associated with candidate responses are applied to the user queries to identify one or more candidate responses that address the user query. One or more responses associated with the best matching Boolean expressions may be presented to the end user as a response to the query. As such, anticipated queries may be precisely answered from data in the knowledgebase. A system in accordance with the '409 patent is used by many consumer agencies—e.g. banks, merchants, service providers—in order to provide end-user customers with end-user support, by way of questions submitted over the Internet. Ideally, typical questions are predicted and lead to a single best response.

Computing device 12 receives the natural language queries that have been input by users to query the knowledgebase, and stores these in database 30. The natural language queries may be received directly at computing device 12, or may be provided to computing device 12 by way of network 10, by way of another server. In any event, database 30 contains entries representative of the collection of user searches for information in a knowledgebase. Ideally, entries in database 30 include the entire collection of queries made to a knowledgebase.

The queries may be collected over time, and stored in one or more tables of database 30. As such, database 30 may include all queries received during a particular time interval. Queries may be include multiple fields, that may used for search and indexing criteria, including date of receipt (DATE_STAMP); query content (QUERY); response (RESPONSE_ID); etc. Other fields (not illustrated) may also be maintained in database 30.

Now, the knowledgebase typically contains information that is related—for example the knowledgebase could be an intranet site, the Internet site of a particular entity (e.g. corporation, partnership, or the like); a wiki maintained by an entity; a knowledgebase answering frequently asked questions; a social network feed-like a twitter feed, or the like. As noted, in a particular embodiment, the knowledgebase may be collection of answers to customer questions. As a consequence, proper analysis of natural language queries made to the knowledgebase may allow for improvement of the knowledgebase and search algorithms used by the knowledgebase. Likewise, the analysis may provide insight into the thoughts or wishes of the users, and allow for the provision of enhanced products or services to the users.

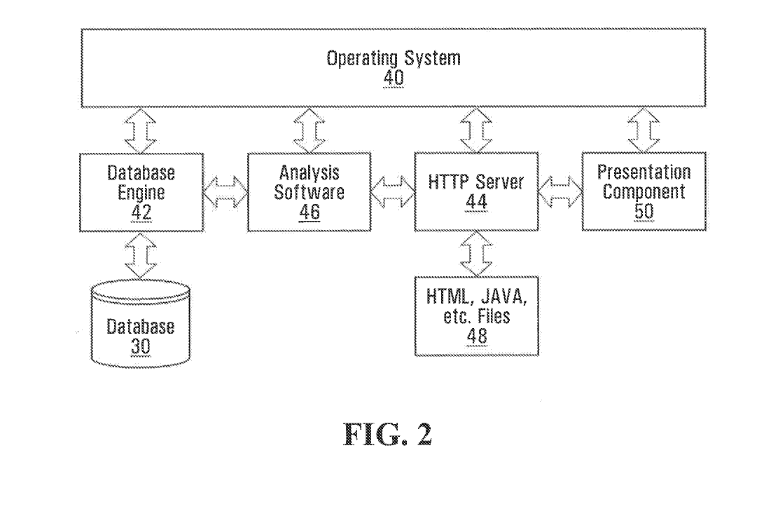

FIG. 2 illustrates a functional block diagram of software components preferably implemented at computing device 12. As will be appreciated, software components embodying such functional blocks may be loaded from medium 20 (FIG. 1) and stored within persistent memory at computing device 12. Alternatively, the software components may reside at another computing device executed as a software as a service. Data to be processed may be provided from computing device 12, and results provided to computing device 12.

As illustrated, typical software components include operating system software 40; a database engine 42; analysis software 46; a presentation component 60; and an optional an http server application 44, exemplary of embodiments of the present invention. Further, database 30 is again illustrated. Again database 30 may be stored within memory at computing device 12. As well data files 48 used by search software 46, presentation component 50 and http server application 44 are illustrated.

Operating system software 40 may, for example, be a Linux based operating system software; OS/X operating system; Microsoft operating system software, or the like. Operating system software 40 also includes a TCP/IP stack, allowing communication of computing device 12 with data network 10. Database engine 42 may be a conventional relational or object oriented database engine, such as Microsoft SQL Server, Oracle, DB2, Sybase, Pervasive or any other database engine known to those of ordinary skill in the art. Database engine 42 thus typically includes an interface for interaction with operating system software 40, and other application software, such as analysis software 46. Database engine 42 is used to add, delete and modify records at database 30. HTTP server application 44 may be an Apache, Cold Fusion, Postures or similar server application, also in communication with operating system software 30 and database engine 42.

Optional HTTP server application 44 allows computing device 12 to act as a conventional http server, and thus provide a plurality of HTTP pages for access by network interconnected computing devices, such as end-user computing devices 14. HTTP pages that make up these pages may be implemented using one of the conventional web page languages such as hypertext mark-up language (“HTML”), Java, javascript or the like. These pages may be stored within files 48.

Analysis software 46 adapts computing device 12, in combination with database engine 42 and operating system software 40, to function in manners exemplary of embodiments of the present invention. Analysis software 46 may analyse stored user queries, and store analysis results to database 30. Results may be further used to generate reports or other representation of the analysis by way of presentation component 50 and/or or present these to users by way of presentation component 50, or to users by way of HTTP pages, or otherwise. Analysis software 46 may for example, include suitable CGI or Perl scripts; Java; Microsoft Visual Basic application, C/C++ applications; or similar applications created in conventional ways by those of ordinary skill in the art.

HTTP pages provided to computing devices 14 in communication with computing device 12 may provide permitted users at devices 14 access to analysis software 46. The interface may be stored as HTML or similar data in files 48.

Of course, any of the above components (e.g. software components, database, etc.) may be distributed over multiple computing devices.

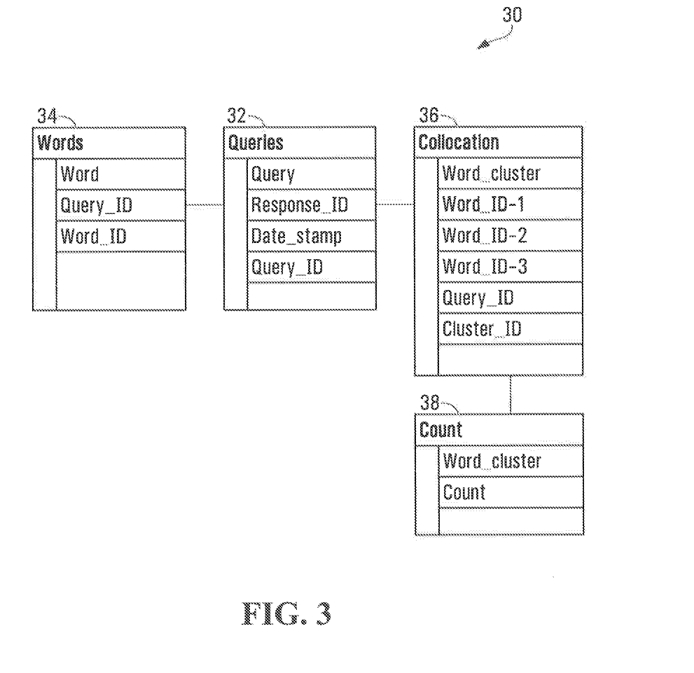

An example organization of database 30 is illustrated in FIG. 3. As illustrated, example database 30 includes three tables: query table 32; word table 34; and word cluster table 36. A tabulated word cluster count for each unique word cluster in word table 34 may be stored in a fourth table 38.

As illustrated, each entry of query table 32 may include a query (QUERY—in ASCII or similar text format); an identifier of a response that was returned to the query (RESPONSE_ID); the date of the query (DATE_STAMP); and a unique numerical identifier of the query (QUERY_ID). As will become apparent, each query stored in queries table 32 is used to populate WORDS table 34, and COLLOCATION table 36. In particular, each word in each query is used to create an entry in WORDS table 34. Each entry in WORDS table 34 identifies a word used in a query (WORD—in ASCII or similar text format); the query that is the source of the word (by numerical query identifier in QUERY_ID); and a unique identifier of the word (in WORD _ID). Word cluster—i.e. words, word pairs (and optionally word triplet, quadruples, etc.) of each query are stored in COLLOCATION table 36. The identity of the word cluster (i.e. word, word pair, triplet, etc. in ASCII or similar may be stored in WORD_CLUSTER). Again, in which query (in QUERY_ID) a particular word cluster may be found, as well as the individual words within the word cluster (WORD_ID_1, WORD_ID_2, WORD_ID_3 . . . —as referenced to table 34) may be stored in table 36. Each word cluster may also be uniquely numerically identified in CLUSTER_ID. Additionally, for each unique word cluster in table 36, a count may be stored in table 38 (COUNT) along with an identity of the cluster in ASCII (in WORD_CLUSTER).

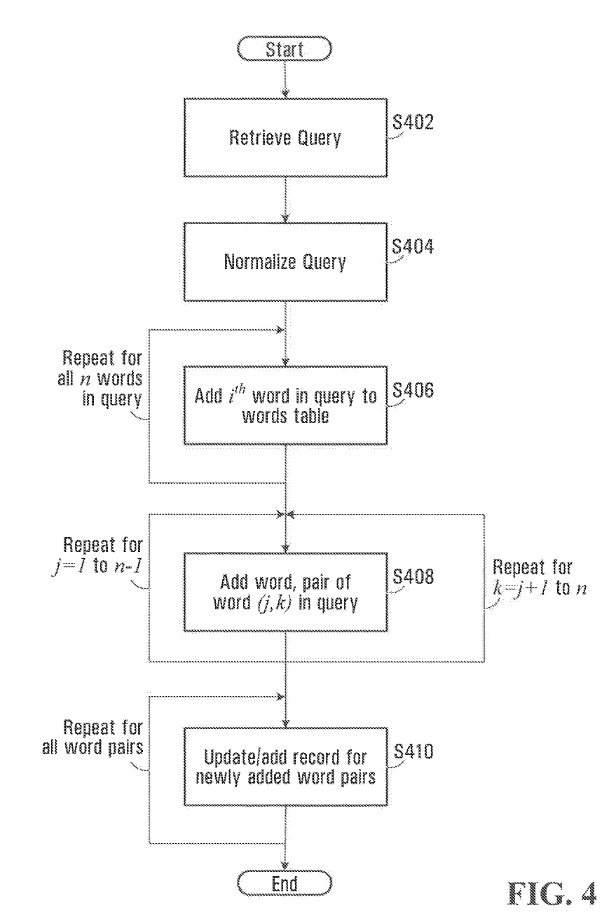

Now, in operation, analysis software 46 processes each stored query in database 30, to identify word clusters (in the illustrated example collocated word pairs) as illustrated in FIG. 4. Specifically, for each entry of interest in table 32, the text is retrieved in block S402 and normalized in block S404. Normalization in block S404 includes removing punctuation; converting the text to a uniform case (e.g. lower case); and removing contractions (e.g. can't →cannot). Optionally, common words like “the”, “a”, “an”, and others may be removed from the normalized query. Likewise, words may be stemmed—e.g. or reducing inflected (or sometimes derived) words to their stem (e.g. running, runs →run). Entries of table 32 may be processed as received.

In block S406, each word of the n words in the query may be added to table 34, and thus tokenized. That is, for each word in the query is added to a separate entry of table 34. Once all words in a query have been added to table 34, collocated word pairs within a query are identified. Specifically, in block S408, for each word in a query, word pairs of that word and each remaining word within the query are constructed. Specifically for a query of n words (as normalized), collocated word pairs may be constructed by pair the j^{th} word in the query with the j+1^{st}, j+2^{nd} . . . q^{th} word, for j=1 to q, in the query. Each word pair so constructed may be stored in COLLOCATION table 36. For consistency, each word pair in table 36 may be constructed with words in the pair in alphabetical order. As well, the identity of each word in a collocated word pair (by WORD _ID, as stored in table 34) may be stored in table 36. At the conclusion of block S408, all the word pairs for an query entry in table 32 will have been added to table 36. Table 36 will thus contain a list of word clusters (e.g. words, collocated word pairs, etc.) in the collection of queries in database 30. Steps S400 may be performed each time a new record is added to table 32, or on demand for all queries in table 32 that have not been processed.

In block S410, table 38 may be updated with a count of each word pair. Specifically, for any word pair added to table 36, a record for that word pair in table 38 may be queried (by WORD_CLUSTER) and an associated count (COUNT) may be updated to increase the count for that word cluster by one (1). If the word cluster does not yet exist in table 38, it may be added.

Optionally, instead of searching for collocated pairs, software 46 may search for other word clusters, such as collocated triplets, or quadruples, or a combination of pairs and triplets, or pairs, triplets and quadruples. Alternatively, software 46 may also search for single words in the queries. Again, single words may be added to table 36.

In the embodiment of FIGS. 3 and 4, word clusters include any two (or more) word pairs that may be formed from a particular query, regardless of how proximate those words are within their associated query.

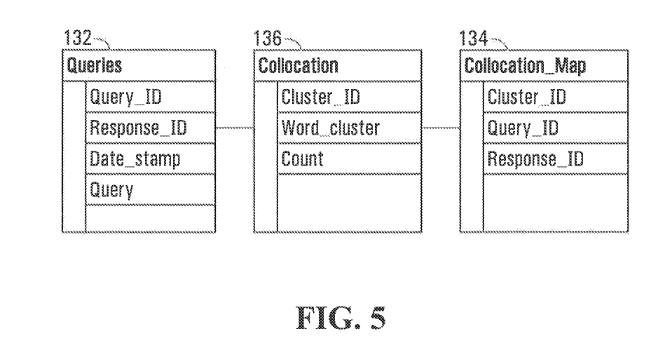

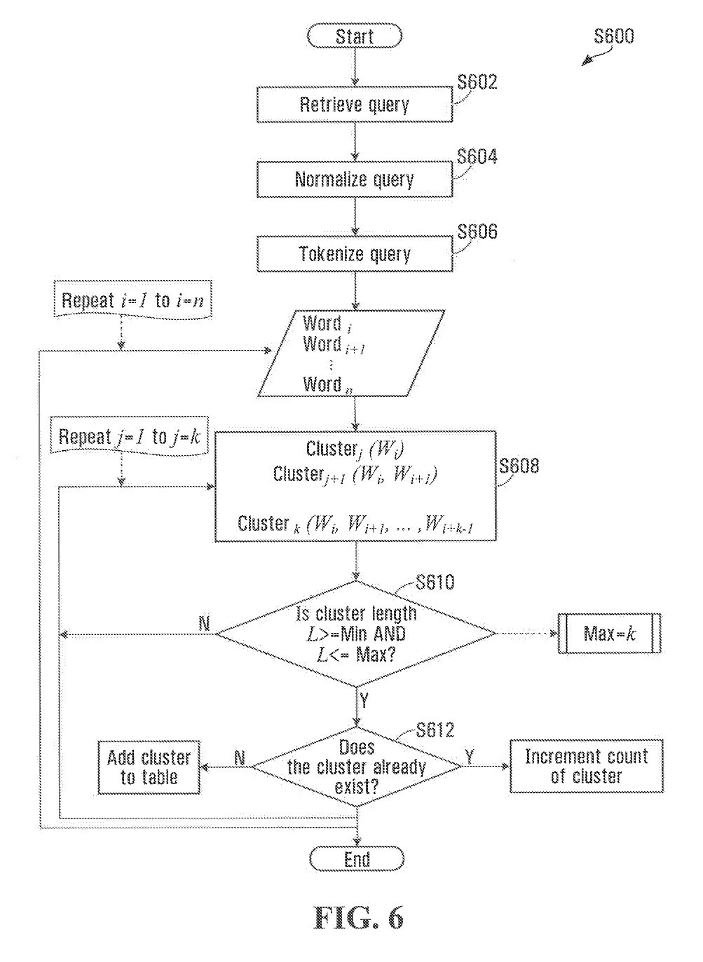

In an alternate embodiment, analysis software 46 processes each stored query in database 30, to identify word clusters formed as one or more adjacent words in the query, as illustrated in FIG. 6. A simplified database schema as depicted in FIG. 5 may be used to store analysis results. Specifically, for each new query entry in table 132, the text is retrieved in block S602, normalized in block S604, and tokenized in block S606 as described with reference to FIG. 4.

The tokenized words in the query may be temporarily stored—in an array or other data structure. Once all words in a query have been added to the data structure, word clusters representing collocated words—in the form of adjacent word pairs, adjacent word triplets, or four five or more adjacent words, and possible single words—within a query are identified. Specifically, in blocks S608-S616, for each word in a query, word clusters of that word and its adjacent word; the adjacent two words; adjacent three words; up to the remaining adjacent words in the query are formed. Adjacency is established in a single direction within the query—from left to right. Each word duster so constructed may be stored in a suitable data structure—for example in table 136 (FIG. 5) of database 30. All clusters of length L, for L=1 to the length of the query k, may be so formed, by repeating block S608 for all clusters of adjacent words of length 1 to k-j (where j is the position the first word in the clusters within the query, and k is the length of the query). At the conclusion of block S616, all word clusters formed of adjacent words in the query may be identified, counted and stored. Table 136 will thus contain a list of word clusters (e.g. adjacent words) in the collection of queries in database 30, links to associated queries and the correct responses may be stored in table 134. Steps S600 may be performed each time a new record is added to table 132, or on demand for all queries in table 132 that have not been processed.

Empirically, collocated pairs and triplets provide more useable information for analysis and presentation. If collocation of three, four or more words in a query is assessed, then shorter collocated word sets contained within longer ones need not be retained in table 36 or 136 (e.g. single words or two word sets contained in any set of three collocated words need not be stored). As noted, single words may also be treated as word clusters.

Of course, other collocation or similar extraction techniques may be used to produce slightly different outputs from the same set of queries.

In any event, after performing blocks S400 of FIG. 4, or S600 of FIG. 6, table 38/table 136 of database 30 will include a list of all collocated word clusters (pairs and optionally singletons, triplets, quadruples, etc.) in the collection of queries in database 30, and the number of occurrences of each word pair in the set of queries stored in table 32/table 132.

This data may be output for visualization by presentation component 50. For example, the data may be output in CSV or similar format for review by a user. Each word, word pair, etc. and its frequency may be extracted from table 38 and output. Preferably, the data is output as a histogram for further graphical presentation. For example, a histogram of the ten (or twenty—or arbitrarily many) most frequently appearing words or word pairs in table 38/table 136 may be output as a word cloud. To do so, entries of table 38/table 136 may be sorted by COUNT field and the desired number of associated word clusters (from the WORD_CLUSTER field) may be provided to visualization component 50.

Presentation component 50 may, for example, include a tag cloud generation tool. Example Tag cloud generation tools, include Wordle. Tag clouds typically show more important (i.e. more frequent) terms in larger fonts, or in differing colours. In any event, tag clouds may be used to quickly identify frequently collocated word clusters (i.e. word pairs) in queries stored in database 30. The tag cloud generation may simply be provided with the word pairs of interest, and their count in database 30.

As such, tag clouds may be used to identify themes in queries in database 30, and thus frequent questions in an associated knowledgebase, or deficiencies in the knowledgebase.

Conveniently, as word clusters are linked to the queries from which they originate (through QUERY_ID), each word pair as presented in the histogram may be used to further present the underlying queries within the queries in database 30 in which the word pair occurs. To this end, presented CSV data may include the queries from which the word pairs originate. Likewise, the presented tag cloud could include links that result in lists of query terms that contain the word pair. The links, could for example, cause execution of an SQL query on table 132 to retrieve the associated quer(ies) for the word pair. Similarly, each query could further link to the response that was used to answer the query, through for example, the RESPONSE_ID of the record in the QUERIES table, which could further be retrieved through a suitable script.

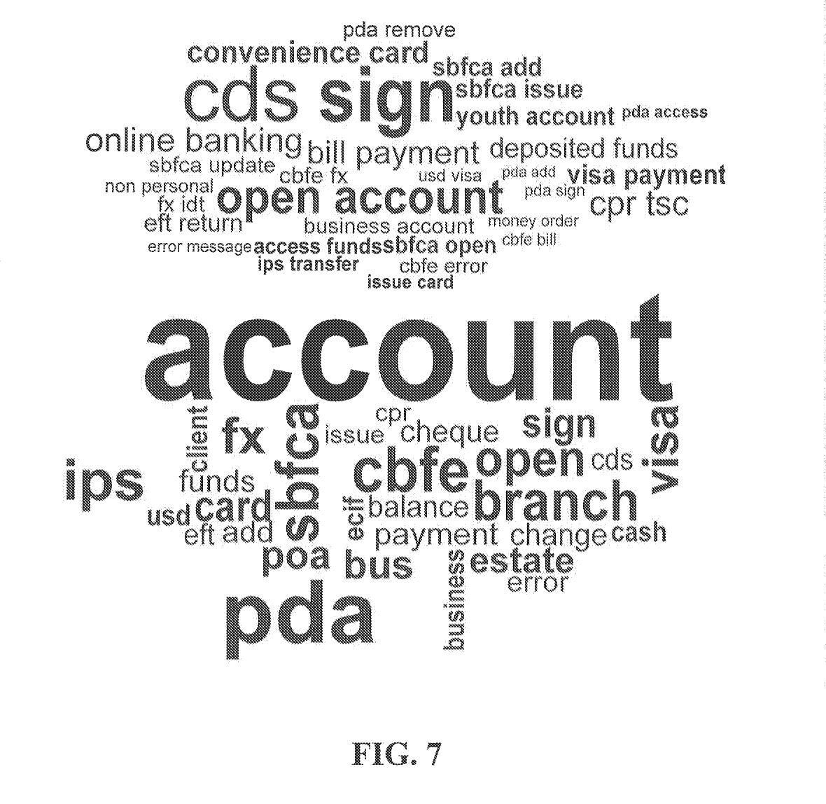

An example tag cloud, is depicted in FIG. 7. This tag cloud was generated from the following queries in database 30

fx idt ouf of balance
cprref bcc
eft return debit
rrs requestor info.
cprref telephone maintenance
fx currency code
pda identification for new account
sdb remove account
special arrangement
cprref telephone maintenance
bus access to deposited funds
ips redeem
ips features of ergic
poa transaction
cprref telephone maintenance
loss report ...... sent link
nsl asked to change password for Sentra Persaud SP00319
nsl asked to change password for Sentra Persaud SP00319
pda reduce cops joint
IPS issue joint
cprref telephone maintenance
pda sign - change name from married to maiden
dispute
cprref telephone maintenance .. spoke to her earlier
tfsa discretionary pricing
ips reference number
op password format
legal
Bist
cprref collections
estate
cprref visa
bizline visa
abgl commonly used numbers

Optionally, a user interface may allow a user to further refine the analysis, by for example limiting the analysed records to specific dates (by, for example, filtering to records in table 36 resulting from queries in the date range). The user interface may be presented as an HTML page by way of HTTP server 44.

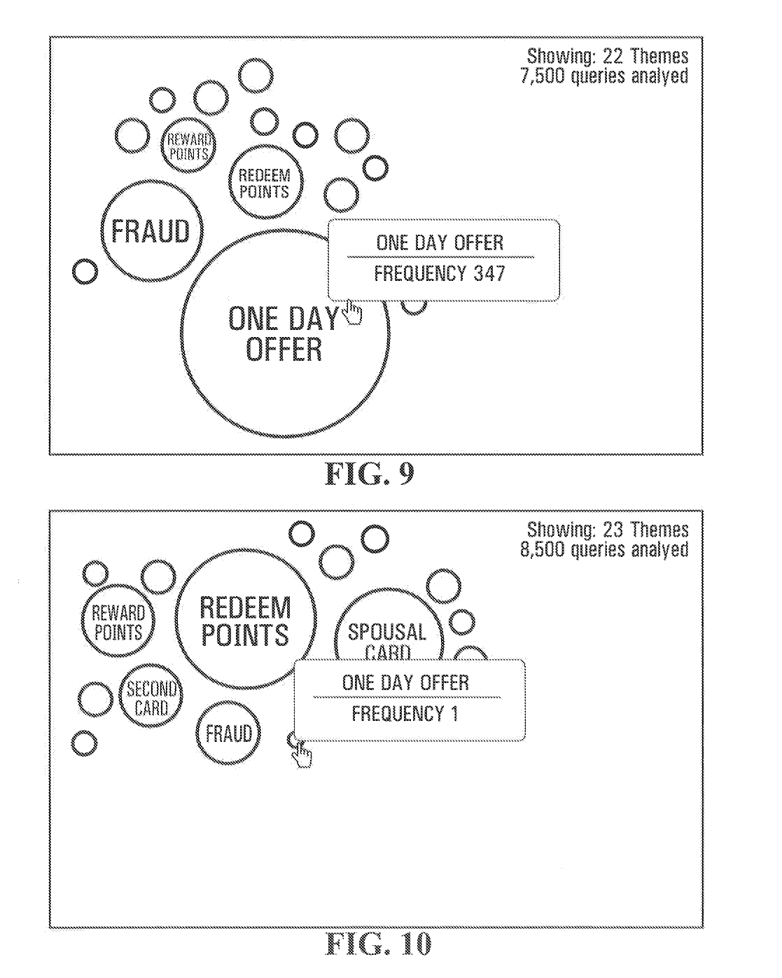

In a further example depicted in FIGS. 9 to 11, software 46 may be used to generate comparative information to assess themes at particular times or over particular time intervals.

For example, the analysis of some arbitrary set of queries at time T₁ is illustrated below Table 1. For simplicity, the actual queries from which the word cluster counts illustrated in Table 1 are derived are not illustrated.

TABLE 1

| Cluster (Theme) | Count T1 |
|---|---|
| credit card | 1100 |
| credit limit | 150 |
| new credit card | 344 |
| Cancel | 111 |
| cancel credit card | 80 |
| Reward points | 219 |
| Redeem points | 75 |
| increase limit | 112 |
| Application form | 2364 |
| Fraud | 908 |
| fraud protection | 700 |
| Statement | 353 |
| pay balance | 143 |
| current balance | 456 |
| Dispute charge | 45 |
| Second card | 2 |
| lost card | 178 |
| Stolen | 123 |
| Payment | 709 |
| miss payment | 42 |
| one-day offer | 347 |
| TOTAL QUESTIONS | 7500 |

Received queries may again be analysed at time T₂ and the resulting twenty-three themes illustrated below are identified Table 2.

TABLE 2

| Cluster (Theme) | Count T2 |
|---|---|
| credit card | 1367 |
| credit limit | 265 |
| new credit card | 550 |
| Cancel | 89 |
| cancel credit card | 71 |
| Reward points | 645 |
| Redeem points | 456 |
| increase limit | 123 |
| Application form | 2399 |
| Fraud | 523 |
| fraud protection | 213 |
| Statement | 500 |
| pay balance | 177 |
| current balance | 790 |
| Dispute charge | 12 |
| Second card | 67 |
| lost card | 209 |
| Stolen | 167 |
| Payment | 900 |
| miss payment | 67 |
| one-day offer | 1 |
| spousal card | 187 |
| TOTAL QUESTIONS | 8500 |

Of note, the example word cluster counts at T₁ are obtained from an analysis of 7500 queries. Example word cluster counts at T₂ are obtained from an analysis of 8500 queries.

As described, queries at T₁ and T₂ are identified. Queries at T₁ and at T₂ may actually represent queries received over some time interval with T₁ and T₂ equal to T_{1f}-T₁ᵢ and T_{2f}-T₂ᵢ, respectively, where T₁ᵢ, T₂ᵢ represent the beginning of the intervals T₁ and T₂, respectively and T_{1f} and T_{2f} represent the end of those intervals T₁ and T₂, respectively. Corresponding records may be retrieved from database 30, and steps S400 may be performed.

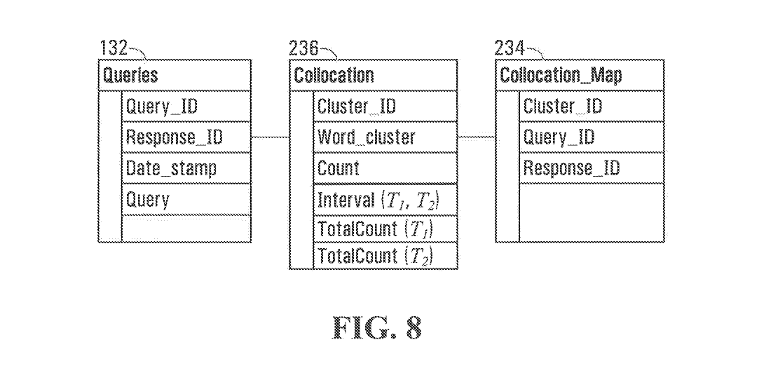

Tables 234 and 236 depicted in FIG. 8, like table 134 (FIG. 5) may be populated for intervals T₁, T₂ and thus would include word/cluster counters counts specific to the interval T₁, T₂. As well, the interval may be stored in table 234.

The identified themes for intervals T₁ and T₂ may be visualized as suitable histograms depicted in FIGS. 9 and 10. Again, visualization component 50 may be used to generate the histograms. Notably histograms of FIGS. 9 and 10 are in the form of word clouds (in the form of bubbles) and depict more prominent themes in larger font (or as larger graphical sets—i.e. bubbles), with less prominent themes depicted in smaller font (or as smaller graphical sets).

Now, interestingly, in order to further analyse the data at times T₁ and T₂, a histogram of change or deltas (Δ) from T₁ to T₂ may also be calculated and presented.

In order to meaningfully calculate such a delta, the relative change in counts from time/interval T₁ and T₂ may be determined. To do this, absolute counts at T₁ may be normalized taking into account that the analysis at T₁ results from an analysis of 7,500 queries. Counts at T₂ can be similarly normalized taking into account that the analysis at T₂ reflects 8,500 queries.

Thus, a measure of the relative difference for any count of a word cluster from T₁ to T₂ for any word cluster (e.g word, word pair, triplet, etc.) may be expressed as

$$\frac{{CountT}_{2} ( {Cluster}_{i} )}{{TotalCountT}_{2}} - \frac{{CountT}_{1} ( {Cluster}_{i} )}{{TotalCountT}_{1}}$$

where CountT₂(Clusterᵢ) is the raw count of a specific word cluster—Clusterᵢ at T2 and CountT₁(Clusterᵢ) is the raw count of the same specific word cluster—Clusterᵢ at T₁. TotalCountT₁, TotalCountT₂, represent the total number of queries analysed at/for intervals/times T₁ and T₂, respectively.

The results are illustrated below in TABLE 3.

TABLE 3

| Cluster (Theme) | Count T1 | Count T2 | Raw Delta |
|---|---|---|---|
| credit card | 1100 | 1367 | 0.014156863 |
| credit limit | 150 | 265 | 0.011176471 |
| new credit card | 344 | 550 | 0.018839216 |
| Cancel | 111 | 89 | −0.004329412 |
| Cancel credit card | 80 | 71 | −0.002313725 |
| reward points | 219 | 645 | 0.046682353 |
| redeem points | 75 | 456 | 0.043647059 |
| increase limit | 112 | 123 | −0.000462745 |
| application form | 2364 | 2399 | −0.032964706 |
| Fraud | 908 | 523 | −0.059537255 |
| fraud protection | 700 | 213 | −0.06827451 |
| Statement | 353 | 500 | 0.011756863 |
| pay balance | 143 | 177 | 0.001756863 |
| current balance | 456 | 790 | 0.032141176 |
| dispute charge | 45 | 12 | −0.004588235 |
| second card | 2 | 67 | 0.007615686 |
| lost card | 178 | 209 | 0.000854902 |
| Stolen | 123 | 167 | 0.003247059 |
| Payment | 709 | 900 | 0.01134902 |
| miss payment | 42 | 67 | 0.002282353 |
| one-day offer | 347 | 1 | −0.04614902 |
| spousal card | 0 | 187 | 0.022 |
| TOTAL QUESTIONS | 7500 | 8500 | |

As will be appreciated, the relative difference may be more directly calculated as

$$\frac{{CountT}_{2} ( {Cluster}_{i} ) - {CountT}_{1} ( {Cluster}_{i} )}{{TotalCountT}_{2} ( {orTotalCountT}_{1} )}$$

Possibly, the relative difference (raw delta) could be graphically or otherwise presented for further consideration. This calculation, however, over-emphasizes small absolute changes that amount to high relative differences from T₁ to T₂.

Put another way, a change of, for example 100/1000 to 300/2000 for one theme is equal in percentage count change to one of 5/1000 to 15/2000 in another theme. The fact that the former theme has raw count values (100, 300) of a larger magnitude than the latter theme (5, 15) means that the change in the former theme is likely more significant and should appear larger in any graphical depiction of change (e.g. theme cloud).

As such, the relative difference may further scaled logarithmically to de-emphasize small absolute changes in the count for any particular cluster between times T₁ and T₂.

To this end, example logarithmic scaling may be performed as follows:

$$scaled Δ = {( \frac{[ \begin{matrix}\frac{{CountT}_{2} ( {Cluster}_{i} )}{{TotalCountT}_{2}} - \\ \frac{{CountT}_{1} ( {Cluster}_{i} )}{{TotalCountT}_{1}}\end{matrix} ] log 10 ( {max ( \begin{matrix}{Count}_{1} ( {cluster}_{i} ) , \\ {CountT}_{2} ( {cluster}_{i} )\end{matrix} )}^{1.5}}{max ( \frac{{CountT}_{1} ( {Cluster}_{i} )}{{TotalCountT}_{1}} , \frac{{CountT}_{2} ( {Cluster}_{i} )}{{TotalCountT}_{2}} )} )}^{3}$$

Notably,

$$max ( \frac{{CountT}_{1} ( {Cluster}_{i} )}{{TotalCountT}_{1}} , \frac{{CountT}_{2} ( {Cluster}_{i} )}{{TotalCountT}_{2}} )$$

represents the maximum of the ratio of counts (expressed as a fraction of the total queries being counted) for the themes (clusters) at T₁ and T₂.

$$[ \frac{\frac{{CountT}_{2} ( {Cluster}_{i} )}{{TotalCountT}_{2}} - \frac{{CountT}_{1} ( {Cluster}_{i} )}{{TotalCountT}_{1}}}{max ( \frac{{CountT}_{1} ( {Cluster}_{i} )}{{TotalCountT}_{1}} , \frac{{CountT}_{2} ( {Cluster}_{i} )}{{TotalCountT}_{2}} )} ]$$

thus calculates the relative difference of the count of Clusterᵢ between interval T₁ and T₂. The maximum (max) function is used in the denominator to ensure equal relative difference in either direction (i.e., increasing or decreasing) will have the same absolute value. An increase from 10/100 to 20/150 will thus have the same absolute value as a change from 20/150 to 10/100.

Now, log 10(max(countT₁(Clusterᵢ)countT₂(Clusterᵢ)))^{1.5} calculates order of magnitude of the larger of the raw count of clusters at T₁ and T₂. Again, the maximum function ensures that equivalent increases and decrease return equal (absolute) values, The exponent (1.5) acts as a multiplier used to exaggerate the magnitude effect of the logarithm function.

log 10(max(countT₁(Clusterᵢ),countT₂(Clusterᵢ)))^{1.5} thus acts as a scale factor that is proportional to the count that has changed, and more particular to a multiple of the logarithm of that count, In this was changes In small counts, are scaled by a smaller scale factor than changes in larger counts. As will be appreciated other scale factors could similarly accomplish such scaling

The additional exponent (3) in

$${[ \frac{[ \begin{matrix}\frac{{CountT}_{2} ( {Cluster}_{i} )}{{TotalCountT}_{2}} - \\ \frac{{CountT}_{1} ( {Cluster}_{i} )}{{TotalCountT}_{1}}\end{matrix} ] log 10 ( {max ( \begin{matrix}{countT}_{1} ( {cluster}_{i} ) , \\ {countT}_{2} ( {cluster}_{i} )\end{matrix} )}^{1.5}}{max ( \frac{{CountT}_{1} ( {Cluster}_{i} )}{{TotalCountT}_{1}} , \frac{{CountT}_{2} ( {Cluster}_{i} )}{{TotalCountT}_{2}} )} ]}^{3}$$

provides a further numeric spread between the typical lowest computed delta values in any dataset and the typical highest computed data values in any dataset, and preserves the sign of the relative difference.

The resulting scaled relative difference values are depicted in TABLE 4

TABLE 4

| THEME | Count T₁ | Count T₂ | Scaled Delta |
|---|---|---|---|
| credit card | 1100 | 1367 | 0.116788553 |
| credit limit | 150 | 265 | 2.472987167 |
| new credit card | 344 | 550 | 2.304057802 |
| Cancel | 111 | 89 | −0.626512978 |
| cancel credit card | 80 | 71 | −0.184678476 |
| reward points | 219 | 645 | 24.31689101 |
| redeem points | 75 | 456 | 43.89690274 |
| increase limit | 112 | 123 | −0.000820587 |
| application form | 2364 | 2399 | −0.274493225 |
| Fraud | 908 | 523 | −15.66178099 |
| fraud protection | 700 | 213 | −43.26164271 |
| Statement | 353 | 500 | 0.696005015 |
| pay balance | 143 | 177 | 0.022993793 |
| current balance | 456 | 790 | 4.963088638 |
| dispute charge | 45 | 12 | −4.294992112 |
| second card | 2 | 67 | 13.551677 |
| lost card | 178 | 209 | 0.00185518 |
| Stolen | 123 | 167 | 0.164269198 |
| Payment | 709 | 900 | 0.161217407 |
| miss payment | 42 | 67 | 0.364765973 |
| one-day offer | 347 | 1 | −65.87005352 |
| spousal card | 0 | 187 | 40.15144876 |
| TOTAL QUESTIONS | 7500 | 8500 | |

Conveniently, scaled relative difference values (ScaledDelta(Clusterᵢ)) may be presented by presentation component 50 as a histogram (e.g. word cloud) corresponding to the word clouds generated at T₁ and T₂.

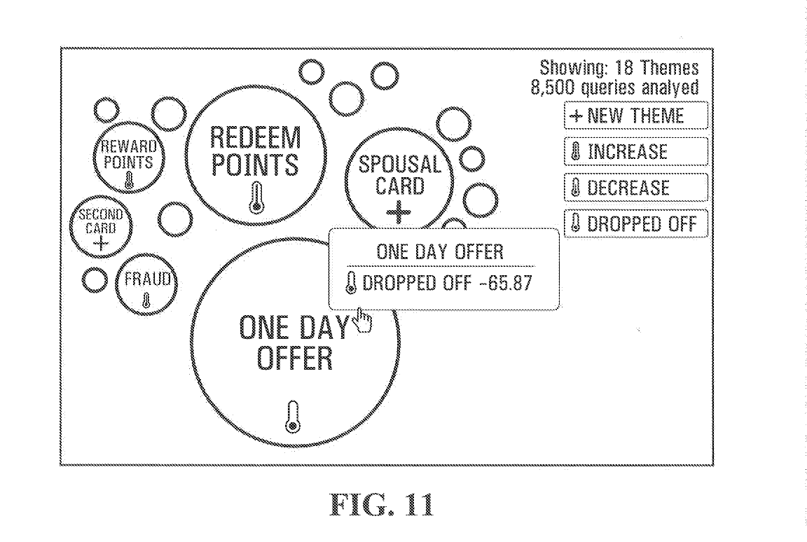

An example histogram representing changes in word cluster frequency from T₁ to T₂ is illustrated hi FIG. 11. As will be appreciated, word clusters (themes) that are trending—i.e. changing frequency/count. Further conveniently, positive and negative relative differences may be presented in contrasting colours—for example values that are negative (i.e. negative change) may be represented by presentation software 50 using a particular colour or font while changes that are positive may be represented in a further colour or font, thus allowing an analyst to determine those queries that are trending (i.e. increasing in frequency) and those that are falling off (i.e. decreasing in frequency).

Additionally, scaled relative differences of word cluster counts that have counts equal to (or near) zero in either interval T₁ or T₂ may be marked as new themes (e.g. “spousal card” and “second card” in the above example), or as dropped-off themes (e.g. “one day offer”). Similar scaled relative differences of word cluster counts that are below a threshold need not/are not illustrated.

Possibly, graphic logos or icons could be used to identify new themes; themes of increasing or decreasing change; or themes that have dropped off. Additionally, mousing or cursing over a particular tag/cloud or bubble may provide additional information about the relative change, and possibly absolute counts reflected by the bubble.

Conveniently, the histogram in the form of a word cloud/histogram may be viewed in overlying relationship or separately to the histogram/word clouds formed at T₁ and T₂ exemplified in FIGS. 9 and 10.

Of course, the above described embodiments are intended to be illustrative only and in no way limiting. The described embodiments of carrying out the invention are susceptible to many modifications of form, arrangement of parts, details and order of operation. The invention, rather, is intended to encompass ail such modification within its scope, as defined by the claims.

What is claimed is:

1. A computerized method of analyzing a knowledgebase comprising:
assembling a collection of queries made by users to obtain information from said knowledgebase;
identifying in each query, sets of collocated words in that query to form a list of collocated word sets in said collection;
from said list, identifying and presenting frequently collocated word sets in said collection.

2. The method of claim 1, further comprising presenting a histogram of frequently collocated word sets in said collection.

3. The method of claim 1, wherein said collocated words comprise adjacent words in said each query.

4. The method of claim 2, wherein said histogram is a tag cloud.

5. The method of claim 1, further comprising modifying said knowledgebase based on said frequently collocated word sets in said collection.

6. The method of claim 1, wherein said knowledgebase comprises a collection of answers to predicted queries.

7. The method of claim 1, wherein each of said sets of collocated words comprise two words.

8. The method of claim 1, wherein each of said sets of collocated words comprise two, three or four collocated words.

9. The method of claim 1, wherein said identifying comprises combining each two word pair in each query to form said two word sets.

10. The method of claim 1, further comprising providing queries within said collection of queries from which any identified word set originates.

11. The method of claim 1, further comprising providing provided responses in said knowledgebase to queries within said collection of queries from which any identified word set originates.

12. A non-transitory computer readable medium, storing computer executable instructions that when executed at a computer perform the method of claim 1.

13. A computerized method of analyzing a knowledgebase comprising:
assembling a collection of queries made by users to obtain information from said knowledgebase;
identifying in each query in said collection in a first time interval, word sets in that query and their frequency to form a first list of frequently used word sets in said collection in said first time interval;
identifying in each query in said collection in a second time interval, word sets in that query and their frequency to form a second list of frequently used word sets in said collection in said second time interval;
for each word set in said first list and said second list, calculating a relative difference between their respective frequency in said first list and second list;
scaling each said relative difference by a scale factor proportional to the frequency for that word set in said first or second time interval to form scaled relative differences; and
forming a histogram of said scaled relative differences.

14. The method of claim 13, wherein said scale factor is proportional to the logarithm of the frequency of that word set in said first or second interval.

15. The method of claim 13, wherein said scale factor equals the logarithm of the frequency of that word set in said first or second interval multiplied by a constant.

16. The method of claim 13, wherein said calculating a difference comprises expressing said difference as a percentage change between their respective frequency calculating a difference between their respective frequency in said first list and said second list.

17. The method of claim 13, wherein each of said word sets comprises one, two, or more words.

18. The method of claim 13, wherein some of said word sets comprise collocated words.

19. The method of claim 13, further comprising generating a histogram of frequencies of word sets in said first list.

20. The method of claim 19, further comprising generating a histogram of frequencies of word sets in said second list.

21. The method of claim 20, further comprising
displaying said histogram of frequencies of word sets in said first list;
displaying said histogram of frequencies of word sets in said second list;
displaying said histogram of said scaled relative differences.

22. The method of claim 21, wherein said histograms are displayed as tag clouds.

23. The method of claim 21, wherein increasing and decreasing scaled relative difference are displayed in contrasting colours.

24. A non-transitory computer readable medium, storing computer executable instructions that when executed at a computer perform the method of claim 13.
